(19) United States
(12) Patent Application Publication
(10) Pub. No.: US 2006/0209668 A1
(43) Pub. Date: Sep. 21, 2006

(54) Integrated DVB receiver-decoder

(76) Inventors: Ian A. Lerner, LaJolla, CA (US); Laurence A. Fish, San Diego, CA (US); Roswell R. Roberts, San Diego, CA (US); Lowell Teschmacher, Carlsbad, CA (US); Omar Choucair, Irving, TX (US)

Correspondence Address: DG SYSTEMS, INC., Suite 700, 750 W. John Carpenter Fwy., Irving, TX, 75039, US

(21) Appl. No.: 10/639,686

(22) Filed: Aug. 13, 2003

Related U.S. Application Data
(60) Provisional application No. 60/402,705, filed on Aug. 13, 2002.

(51) Int. Cl. H04J 11/00; H04J 3/04

(52) U.S. Cl. 370/206; 370/536

(57) ABSTRACT

An integrated receiver-decoder device for in-home use demodulates and decodes QPSK modulated MPEG-DVB formatted signals received via satellite transmission. The receiver-decoder is capable of simultaneously providing both IP data output and analog audio output for direct connection to a user's home entertainment equipment and/or PC. The receiver-decoder housing includes a front panel user-interface and is designed for connection to an external satellite receiver dish. An on-line upgradable software operating system controls all receiver-decoder operations including demodulating, DVB signal decoding, selecting and configuring audio and IP data channels for output.

### CROSS-REFERENCE TO RELATED APPLICATIONS

The present application claims priority from related provisional application Ser. No. 60/402,705, filed Aug. 13, 2002, entitled “Integrated DVB Receiver-Decoder”, which is hereby incorporated by reference into this application.

### FIELD OF THE INVENTION

The present invention relates to extraterrestrial satellite signal receiver systems and, more particularly, to a home-based satellite signal receiver-decoder device for demodulating and decoding a QPSK modulated MPEG-DVB signal received via satellite that is capable of simultaneously providing both IP data and audio output.

### SUMMARY OF THE INVENTION

The present invention provides a compact light-weight integrated RF satellite signal receiver-decoder device, convenient for in-home use, for delivering both IP digital data and streaming audio content directly to a user's home entertainment equipment or PC. The receiver-decoder device connects to an external satellite receiver dish for receiving conventional QPSK modulated RF signals transmitted via extraterrestrial satellite. In a preferred embodiment, the integrated receiver-decoder demodulates and decodes QPSK modulated MPEG-DVB formatted signals and is capable of simultaneously outputting both IP data and one or more analog audio channels. An upgradable software based operating system controls all receiver operations including demodulating, DVB signal decoding, selecting and configuring audio and IP data channels for output.

### BRIEF DESCRIPTION OF THE DRAWINGS

These and other features and advantages provided by the invention will be better and more completely understood by referring to the following detailed description of presently preferred embodiments in conjunction with the drawings of which:

FIG. 1 is a high level block schematic diagram of a receiver-decoder device in accordance with the present invention.

### DETAILED DESCRIPTION OF AN EXAMPLE EMBODIMENT OF THE INVENTION

In the following description, for purposes of explanation and not limitation, specific details are set forth, such as particular circuits, circuit components, interfaces, techniques, etc. in order to provide a thorough understanding of the present invention. However, it will be apparent to one skilled in the art that the present invention may be practiced in other embodiments that depart from these specific details. In other instances, detailed descriptions of well known methods and programming procedures, devices, and circuits are omitted so as not to obscure the description of the present invention with unnecessary detail.

The MPEG-DVB receiver-decoder of the present invention outputs at least one stereo audio channel, and at least one RS232-Async data port. In an example embodiment, the receiver-decoder device includes a front panel with a display and controls for manual operation and an interface for remote control operation.

In the present example embodiment, the DVB receiver-decoder implements at least the following functions:
provides a conditional access interface
demodulates a DVB compatible QPSK satellite signal
Decodes MPEG I Layer II Encoded Audio
Outputs at least a single stereo audio analog signal
Sources MPEG serial data output
Sources serial asynchronous data output (Ancillary Data)
Demultiplexing of an MPEG compliant transport stream
Processing of DVB Program Specific Information (PSI) and Service Information (SI)
Allows Input Data Rates of up to 40 Mbps
Simultaneously provides both IP data output and streaming digital MPEG audio output
Allows downloading and storing of music program content for forwarding at a later time to a user's PC or stereo equipment for playback (“store and forward” feature)

The DVB receiver-decoder may be controlled locally using, for example, StarGuide Digital Network's Windows 95/NT Network Management System™ (NMS) or remotely using a 9600-Baud dial-up telephone modem. The main control software is upgradable via satellite link, modem or via a direct RS232 connection.

The DVB receiver provides output audio channels. This allows users to take advantage of MCPC transmission topology. The controller provides data to the decoder DSP for output.

The controller also monitors the status of the decoder and User Interface. It verifies that the decoder is operating within acceptable limits. It also alarms the user if any detectable malfunction occurs. This allows the operator to be fully informed regarding the health of the system.

The controller core also includes the ability to de-crypt the input data stream using the Multi2 algorithm. This sequence may be easily modified by a head-end NMS.

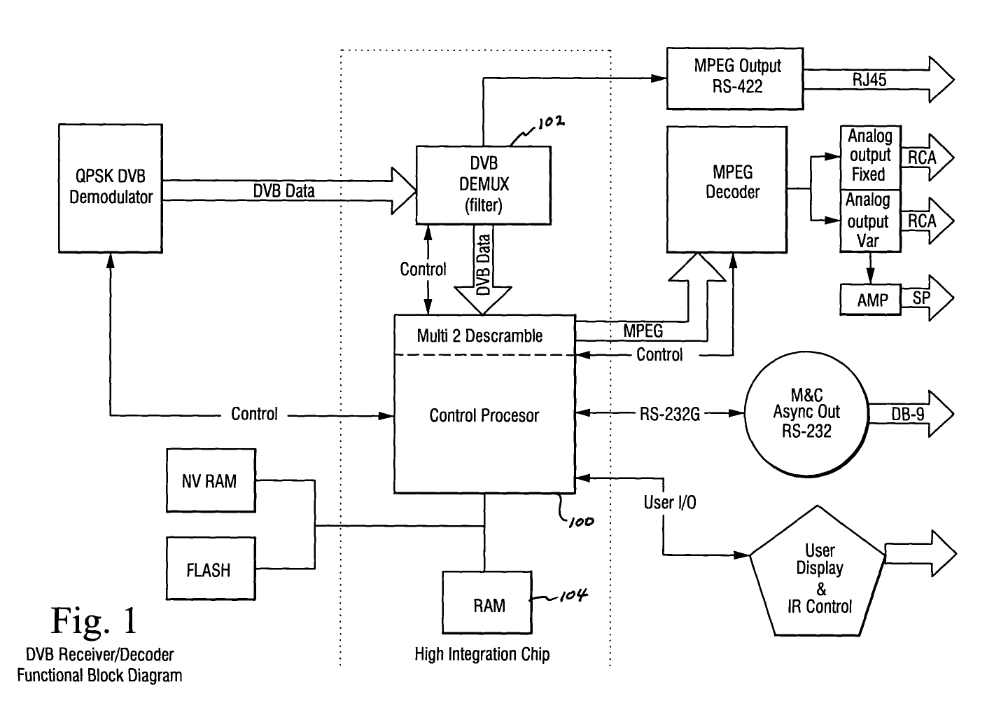

FIG. 1 is a functional block diagram of the receiver-decoder. In a preferred embodiment, at least the control processor (100), DVB Demultiplexer (102) and RAM (104) are formed on a single integrated chip. Transmitted data is received through the QPSK DVB satellite signal demodulator and then forwarded to DVB demultiplexer (102). From there, data is parsed (filtered) by the demultiplexer, de-scrambled by the control processor and forwarded to the proper destination or discarded. Possible data destinations include the microprocessor (for in-band data), the audio decoder, and the asynchronous data output.

For example, Control Processor (100) extracts MPEG Data from the DVB Data, de-scrambles it and then sends it to the MPEG Decoder. In this manner, Control Processor (100) may not only de-scramble incoming received MPEG data but may also provide alternatively sourced MPEG data (such as from a local storage device) to the MPEG decoder. Such alternative source data may comprise, for example, the insertion of previously downloaded and stored “targeted” commercials (i.e., directed toward a particular demographic) for inserting between sets of songs or some form of prerecorded/predetermined “canned” music for use, for example, when the satellite RF signal is lost or down.

Satellite Signal Demodulator

The DVB receiver supports a DVB compliant QPSK demodulator. An L-Band RF signal may be input through a standard F-type connector. The demodulator is responsible for recovering the digital data being sent from a streaming digital content source or “head-end.” The output of the demodulator is a byte wide (8-bit) data stream that includes synchronization signals.

In a preferred example embodiment, the receiver operates at 20-30 mbps with corresponding data rates ranging from roughly 23 to 33 mbps.

Data Descrambler

In a preferred embodiment, encoded transmission signal descrambling is performed by Central Processor (100) after the DVB Demux (demultiplexer) filtering and before MPEG Decoding. The integrated receiver-decoder include appropriate software store in RAM for supporting the descrambling (decoding) of at least Multi-2 data scrambling—a well known form of data encryption which, if used, is usually performed at the broadcast system head-end prior to transmission. This function is performed by the control processor. DVB data is provided directly from the demodulator section of the receiver-decoder to the control processor for de-scrambling.

The keys used by the descrambler are provided to the receiver through the satellite channel as PSI data (e.g., by the network management system).

DVB Demultiplexer

The DVB demultiplexer enables the selection between multiple audio/data channels via a front panel interface and through the use of standard DVB defined Program Specific Information (PSI) and Service Information (SI) tables. In the present embodiment, demultiplexer (102) acts primarily as a filter—i.e., it may receive, for example, a full 30 Mbps data stream transport from the demodulator, but it “filters” out various undesired data services (for example, the present example embodiment of the integrated receiver-decoder is set up for only providing a single audio and a single data stream) and forwards particular desired data “substreams” or program services unmodified to the control processor. In this example, the “filtered” output is, for example, on the order of 500 Kbps of In-Band PSI data plus 192 Kbps of audio data, plus 19.2 Kbps of asynchronous data. The total is equivalent to less than a 800 Kbps data rate. This is better than attempting to process the entire 30 Mbps stream, which most conventional processors could not handle, although in a preferred embodiment control processor (100) runs at least at 27+ MHz and could easily handle up to 1 Mbps of filtered data. The control processor commands the Demultiplexer to control which data substreams to pass for processing. A different data substream is passed as the user changes from channel to channel. For example, an audio channel is sent to the audio decoder. In this manner, the demultiplexer may provide simultaneous demultiplexing of at least an audio channel, an asynchronous data channel, and any PSI tables being received.

MPEG Audio Dec der

In a preferred example embodiment, the audio decoder circuit is a single integrated circuit that decodes an MPEG data stream and presents the decoded data to an external digital-to-analog converter (DAC) to produce the analog audio output. The audio decoder receives input data and a clock signal from the demultiplexer. The interface between the demultiplexer and the decoder is an 8-bit data parallel data bus (or a serial data bus may be used).

Digital Data Output

The MPEG audio for a selected audio channel is also output in digital serial form with a smooth data clock. This data clock is derived from the same clock signal used to clock data through the DAC. This output is provided through a conventional RS-422 driver IC.

Compression Standard:

The audio decoder is capable of decoding both MPEG 1 and layer II encoded audio.

Input Data Modes:

The input to the decoder may either be a MPEG2 TS stream or a raw MPEG 1 layer II stream.

The audio decoder provides, at least, compressed bit rates of 64, 128 and 192 kbps and support both dual mono and joint stereo encoding modes. The decoder supports sampling rates of 32 and 48 kHz.

Control Processor

The control processor configures and monitors the receiver-decoder circuit functions. It handles input and output interfaces (e.g., front panel I/O) and monitors the audio decoder. The control processor also processes the DVB Service Information (SI) and Program Specific Information (PSI) tables used to configure the receiver to the satellite delivery system.

A variety of different types of memory storage are provided and accessible by the control processor including, for example, flash memory (non-volatile) for code storage, static RAM for scratch pad memory, and a serial EEPROM or other type of non-volatile memory for parameter storage.

User Interface and System Control Arrangement:

The DVB receiver-decoder is individually and group addressable through the received satellite signal. Each receiver is provided with a unique physical address. Physical (receiver) addresses may be grouped to form logical (group) addresses for controlling multiple receivers.

The DVB receiver-decoder operates under local control via RS-232 asynchronous port. This feature aids in the installation and troubleshooting of the receiving equipment.

The DVB receiver-decoder is provided with a front panel that is used to control basic operational functions. The front panel (not shown) comprises at least an LED display and a keypad. The LED display provides a visual indication of current receiver settings and the keypad may be used to modify receiver settings.

Software Download

The receiver system accepts software downloads (e.g., operating system upgrades) via an IP digital data transmission network management system (NMS) from, for example, a service or content provider. A software storage flash memory is used that is capable of being updated while operating system control program is running (e.g., the operating system code is either run from RAM or the flash memory is configured for dual access/usage).

Phy ical Interfaces:

Front Panel Interfaces

In an example embodiment, the receiver-decoder front panel provides several features that are interfaced to the control processor: an LED output status display, a keypad or pushbuttons, and an IR transceiver for use with a hand-held remote control device.

Audio Output Interfaces

The decoder contains two analog audio outputs through RCA connectors. The analog audio is feed directly from the real-time audio decoders to the RCA connectors so that the quality of the signal is as good as possible (e.g., the cable length is kept to a minimum). The Audio Decoder utilizes 18 bit D/A converters. One output is fixed level and the other is variable output. The variable output drive is used to drive a power amplifier which may be used to drive audio speakers directly.

MPEG Output Interfaces

Each Decoder has an associated Synchronous data port. The Synchronous ports use RJ-45 connectors and can support rates of 64K, 96K, 128K, 192K, 256K. The output are standard RS-422 electrical levels.

RJ45 connectors are provided for RS422 serial output.

Data Interfaces

Each Decoder has an associated asynchronous data port. The asynchronous ports use DB-9 connectors and can support baud rates of 300, 1200, 2400, and 9600 baud.

Software System Overview:

The IRD operating system software controls all of the aspects of the receiver's operation. Its major functions include the user interface, controlling the demodulator, configuring the channels being received, receiving the configuration and authorization from the satellite, and programming the audio decoder. The operating system software also examines the incoming data stream and reconstruct tables needed to define each of the services and how they need to be decoded.

Basic Receiver Software

In addition to the standard audio channel, the receiver software enables the receiver to decode an asynchronous data channel.

U er Interfac Operations

The user interface on the IRD includes the front panel GUI and the features that need to be implemented. Many of the details of the User Interface need to be resolved between Mickey and StarGuide but this document describes several possible approaches and provides as many details as possible.

Front Panel Interface

The motherboard communicates with the front panel in order to drive the displays and to read the front panel buttons. Preferably, the interface implemented between the motherboard and the front panel is a “smart” protocol that allows for a minimal number of interconnects. Other options for the interface that include either a byte wide data interface or a three wire serial interface. The byte wide interface is faster while the serial interface uses less interconnects. The protocol used across the interface depends on the style of the interface (parallel or serial) but includes the ability to write data to the various display elements and read data from each of the buttons.

IR Remote

The front panel also contains an infra-red remote control interface. The details of the remote control and the buttons it contains need to be specified. The interface between the IR on the front panel and the microprocessor can either be included with the front panel interface described in the previous section or it can be located on a separate interface. StarGuide prefers that the IR Remote be connected through the same “smart” interface as the buttons and display.

Buttons

The following is a list of front panel buttons and their associated functions:

| Button Name | Function |
|---|---|
| Channel Up | Increments the channel or numeric entry |
| Channel Down | Decrements the channel or numeric entry |
| Band Up | Increments the alpha portion of the channel number |
| Band Down | Decrements the alpha portion of the channel number |
| Volume Up | Increases the volume |
| Volume Down | Decreases the volume |
| Menu | Enters the programming mode menu |
| Timer | Enter timer programming mod |
| Display | Changes the front panel display |
| Set | Used as an “enter” when in a configuration menu |
| Power | Shuts down the front panel (internal power remains on) |

Di play

The following is a list of display panel features and their respective functions:

| Di play Feature | Description |
|---|---|
| Signal LED | Indicates when the satellite signal is acquired |
| | and functional |
| Stereo LED | Indicates when the decoded audio channel in |
| | stereo |
| Version Up | Indicates when a new version of software is |
| | available??? |
| Timer On LED | Indicates if the timer is on |
| Timer Off LED | Indicates if the timer is off |
| Three Seven-Segment | Used for the channel information, volume |
| LED's (with period) | information and data entry |

Various User Features:
Wakeup Timer(s)

The IRD contains at least one wakeup timer that may be programmed to power up turn the IRD (similar to a wakeup alarm). There may be up to two of these types of timers. The timers may also be set/configured using the front panel buttons and/or using the remote control device.

Sleep Timer

The IRD contains a sleep timer that may be used to turn the IRD off when the countdown timer expires. This feature is configurable from the front panel as well as the remote control.

Configuration:

Several features are able to be configured through the either the front panel, the remote control, or the M&C port. The types of configuration that can occur include: setting the satellite frequency and data rate (initial configuration), setting the wakeup timer(s), setting the sleep timer, and setting the clock.

Demodulator

The demodulator block of code provides configuring and monitoring the demodulator circuit hardware. The following sections describe some of the basic features of the demodulator code:

Configuration:

The demodulator configuration code is responsible for configuring the required IC's. In general, this section of code configures the required registers in the tuner and demodulator.

Acquisition

The demodulator acquires the satellite signal. The acquisition code is responsible for setting up the correct frequency and data rate as well as monitoring the process to ensure proper acquisition. It corrects for any failures and is robust to ensure acquisition.

Status/Monitoring

The operating system control software continually monitors the status and health of the demodulator hardware block. The types of errors that should be detected and reported include PLL lock failure, acquisition failures, out of lock conditions, and any communication errors with the demodulator.

Demultiplexer and Descrambler Control

Once the demodulator is locked and providing data, the data is sent to the Multi-2 descrambler and then to the demultiplexer. Both of this hardware pieces need to get configures through 8 bit register interfaces and then monitored over time to make sure they are operating correctly.

Configuration:

Both the descrambler and the demultiplexer is configured through an 8 bit wide bus interface. They each contain a series of registers that are used to configure them. Both of these devices may be reconfigured over time as the system changes. For example, the descrambler is reprogrammed each time a new set of decryption keys is received. Both the demultiplexer and the descrambler are reconfigured every time the user changes channels.

Status Monitoring

Both the descrambler and the demultiplexer are monitored for operational status. The descrambler includes a status register that indicates if there are any FIFO overflow or underflows as well as any internal processing errors.

In-band Signaling

The operating system software performs in-band signal processing. The control processor looks at incoming PSI transport packets and reconstructs the tables required for normal operation.

PSI Tables

The configuration data sent over the satellite is known as Program Specific Information (PSI). There are many different table types provided as both part of the standard DVB specification as well as custom tables which may be sent over the satellite broadcasting system. The tables being sent contain all of the information needed for the IRD to select a channel and decode its signal. Some of these tables provide the descrambling keys used for conditional access while other tables provide details on the satellite carriers or individual services being used. The receiver-decoder operating system software examines these incoming tables and gleans the specific information required for operation. Portions of the data received is kept in memory for quick and efficient operation during channel changes.

PCR

One of the in-band data streams received is a Program Clock Reference (PCR). The PCR is used to synchronize the decoder's system clock to the clock at the head-end. Although, much of the PCR processing is handled by the demultiplexer hardware, software is also used to help control this function. For example, the software determines the correct PID for the PCR and applies it to the demultiplexer hardware. The software may also be used to adjust the system VCXO based on the PCR data received from the demultiplexer. This involves comparing several registers and writing a new value out to the demultiplexer.

Software Download

One of the types of data used by the PSI is software download data. For example, the integrated receiver-decoder (IRD) is capable of upgrading its control processor software via satellite download.

Audio

The audio decoder is a single integrated circuit that decodes the channel of audio selected through the demultiplexer. The decoder needs to be initially configured and then monitored. Volume control may be configured digitally through the decoder IC or with an analog control external to the decoder.

Configuration:

The audio decoder is configured through a serial interface. Registers within the device are read from and written to through this serial I/O interface.

The control software includes the ability to mute the audio output. In general, this feature is utilized only during channel changes and power up.

Volume Control

The decoder IC includes the ability to control volume through a register interface. This feature may be utilized for the volume control feature. Alternatively, a fixed line out audio signal may be provided, in which case the volume control is implemented using an external analog circuit. In that embodiment, the volume control implementation is hardware dependent.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A satellite transmission receiver-decoder system, comprising:
a control processor, a DVB signal demultiplexer and a digital data storage memory integrated on a single semiconductor chip; and
a QPSK digital video broadcast (DVB) signal demodulator electrically coupled to said DVB signal demultiplexer and said control processor;
wherein the receiver-decoder system demodulates and decodes QPSK modulated MPEG-DVB formatted signals received via satellite transmission.

2. The receiver-decoder system of claim 1 further comprising an MPEG decoder.

3. The receiver-decoder system of claim 1 further comprising a encoded signal descrambler.
